(19) United States
(12) Patent Application Publication
(10) Pub. No.: US 2016/0014220 A1
(43) Pub. Date: Jan. 14, 2016

(54) INFORMATION SEARCHING SYSTEM USING LOCATION INFORMATION

(71) Applicant: HYOUNGSEOG KIM, Gyeonggi-do (KR)

(72) Inventor: HYOUNGSEOG KIM, Gyeonggi-do (KR)

(21) Appl. No.: 14/792,624

(22) Filed: Jul. 7, 2015

(30) Foreign Application Priority Data
Jul. 9, 2014 (KR) 10-2014-0085831

(51) Int. Cl. H04L 29/08; G06F 3/0484; G01C 21/36; G01C 21/28; G01C 21/34; H04L 12/58; H04W 4/02

(52) U.S. Cl. CPC H04L 67/18; H04L 67/16; H04L 51/20; G06F 3/04847; H04W 4/023; G01C 21/28; G01C 21/3407; G01C 21/3446; G01C 21/3617

(57) ABSTRACT

According to an embodiment of the present disclosure, an information searching system may automatically analyze the location of food trucks located near a user based on location information, allowing the user to easily select a food truck.

### CROSS REFERENCE TO RELATED APPLICATIONS

This patent application claims priority under 35 U.S.C. §119 to Korean Patent Application No. 10-2014-0085831 filed on Jul. 9, 2014, in the Korean Intellectual Property Office, the disclosure of which is incorporated by reference herein in its entirety.

### TECHNICAL FIELD

Embodiments of the present disclosure relate to location based services using in mobile communication terminals, and more specifically, to information searching system that may automatically analyze the location of food trucks located near a user based on location information of the user, allowing the user to easily select a food truck.

### DISCUSSION OF RELATED ART

As portable terminals such as mobile phones, smartphones, or tablet PCs spread, various location based service (LBSs) may come in use.

More and more people prefer to be served meals in a quick and simplified way, and thus, street vendors gain popularity.

Street vendors usually sell food using food trucks.

However, users are not aware of whether his favored food truck is located nearby or which food truck offers more customer satisfaction.

Thus, a need exists for a system for providing users with information on food trucks, such as location, preference, and other customers' evaluation.

### SUMMARY

According to an embodiment of the present disclosure, a food truck and user searching system using location information comprises a location tracking unit tracking a current location of a user and a current location of a food truck using a communication terminal, a location displaying unit displaying the current location of the user and the current location of the food truck based on location information obtained through the location tracking unit, a messaging unit computing a distance between the user and the food truck, and when the distance is within a predetermined distance, sending a notification message, a travel route and travel means providing unit providing a travel route and a travel means based on the location information between the user and the food truck, and a schedule storage unit storing a schedule of the food truck. A location of a food truck located within a distance preset by the user based on the current location of the user may be displayed, and a notification message may be sent. When there is a food truck predicted to come within the distance preset by the user based on the current location of the user based on the schedule stored in the schedule storage unit, a notification message may be sent.

The location displaying unit may search and display the current location of the user to an owner of the food truck based on the current location of the food truck.

The food truck and user searching system may further comprise a food truck preference storage unit storing an evaluation point of the food truck. Information on an evaluation point of the food truck evaluated by the user may be stored in the food truck preference storage unit.

When the food truck comes within the distance preset by the user based on the current location of the user, the location displaying unit may list food trucks in order of a shortest travel route or travel time considering a travel route, travel time and travel means of the user or may list the food trucks in order of preference of the food trucks.

The user may search a food truck and register a particular food truck as a food truck of interest. When the food truck of interest is located within the distance preset by the user, a location of the food truck of interest may be displayed, and a notification message may be sent.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a block diagram illustrating information searching system using location information according to an embodiment of the present disclosure;

FIG. 2A is a view illustrating a process for enrolling in membership and registering information on a food truck owner;

FIG. 2B is a view illustrating a process for enrolling in membership and registering information on a user;

FIG. 3 is a view illustrating an example in which the location of a food truck located within a distance preset by a user is displayed and a notification message is transmitted, according to an embodiment of the present disclosure;

FIG. 4 is a view illustrating an example in which an information searching system provides travel information according to an embodiment of the present disclosure;

FIG. 5 is a view illustrating an example in which a food truck owner searches a user of interest for the user's location according to an embodiment of the present disclosure;

FIG. 6 is a view illustrating a screen displayed on a terminal of a food truck owner according to an embodiment of the present disclosure;

FIG. 7 is a view illustrating a screen on which a food truck owner registers a schedule according to an embodiment of the present disclosure; and

FIG. 8 is a view illustrating an example in which a notification message is sent to a user so that the user may predict his/her consumption of food from a food truck whose schedule has been previously registered, according to an embodiment of the present disclosure.

### DETAILED DESCRIPTION OF EXEMPLARY EMBODIMENTS

Hereinafter, exemplary embodiments of the present disclosure will be described in detail with reference to the accompanying drawings. The present disclosure, however, may be modified in various different ways, and should not be construed as limited to the embodiments set forth herein. The same reference denotations may be used to refer to the same or similar elements throughout the specification and the drawings. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

As used herein, the term “terminal” or “communication terminal” may include, but is not limited to, a portable phone, a portable terminal, a mobile phone, a smartphone, a tablet PC, or any other device that may perform communication using a wireless communication technology.

As used herein, the term “food truck” may refer to an automobile that serves food. The food truck is not limited to a particular type of truck. The food is not limited to a particular type of food. The term “food truck” may mean any type of transporting means that may serve, but is not limited to, food, coffee, fruits, or vegetables.

As an example of the information searching system, a system for obtaining a distribution of food trucks or users is described for the purpose of description, but embodiments of the present disclosure are not limited thereto. For example, embodiments of the present invention may also apply to any other information searching system that may provide information on a distribution of users or movable devices or objects through a terminal.

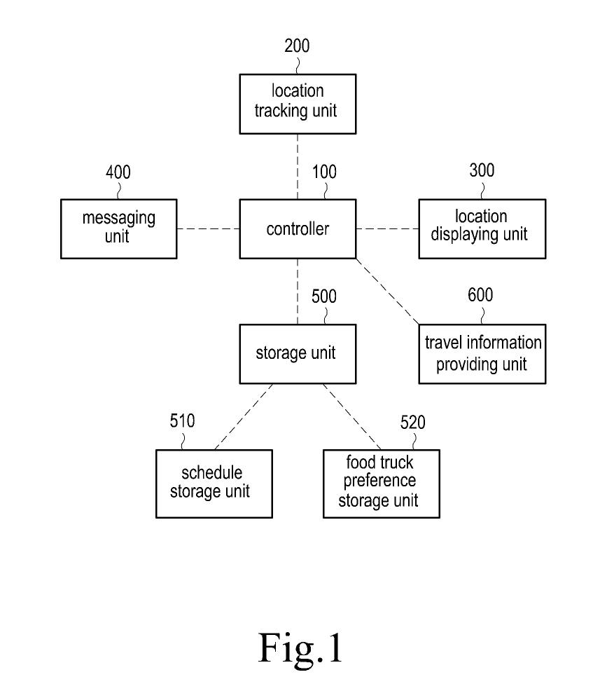

FIG. 1 is a block diagram illustrating an information searching system using location information according to an embodiment of the present disclosure.

Referring to FIG. 1, the information searching system includes a location tracking unit 200, a location displaying unit 300, a messaging unit 400, and a controller 100. The location tracking unit 200 tracks a user's current location and a food truck's current location using a communication terminal, The location displaying unit 300 displays the user's current location and the truck's current location based on location information obtained through the location tracking unit 200. The messaging unit 400 computes a distance between the user and the food truck, and when the distance is within a predetermined value, sends a notification message. The controller 100 controls the location tracking unit 200, the location displaying unit 300, and the messaging unit 400.

The location tracking unit 200 may include, but is not limited to, a Global Positioning System (GPS)-based location recognizing device including a GPS receiver included in the communication terminal. The GPS obtains a coordinate by computing a distance between a GPS satellite and the GPS receiver.

Locating using the GPS might not find an exact indoor position or might not find an exact Z-axis position of a three-dimensional (3D) coordinate. According to an embodiment of the present disclosure, information searching system may use a Wi-Fi-based locating scheme separately or in addition to the GPS. The Wi-Fi-based locating scheme may be a technique that finds a position using an IP address received from an Internet service provider (ISP).

The information searching system may automatically obtain the current locations by associating wireless signals received from the GPS, a base station of a mobile communication system, and/or a Wi-Fi Access Point (AP) with an existing database (DB) containing accumulated information (e.g., location information).

Information on the locations of the user and the food truck may be stored in a storage unit 500. The stored information may include the user's personal information, including the user's name, picture, or contact information, and/or the name, picture, menu, or instruction of the n of the food truck. The various information may be collectively referred to herein as the location information, The various information may be displayed through the location displaying unit 300 to, e.g., the user.

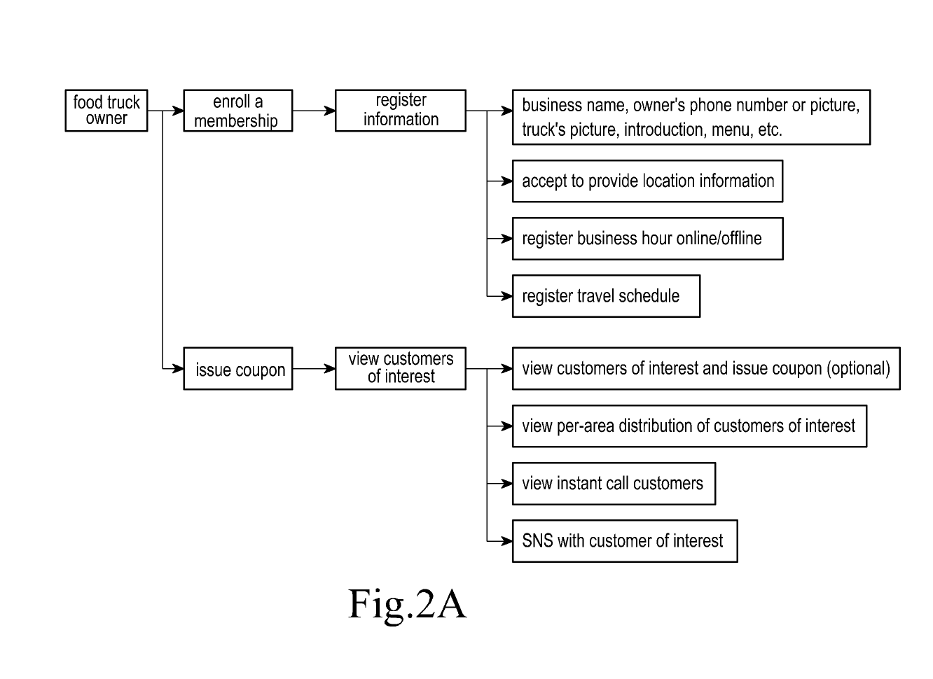

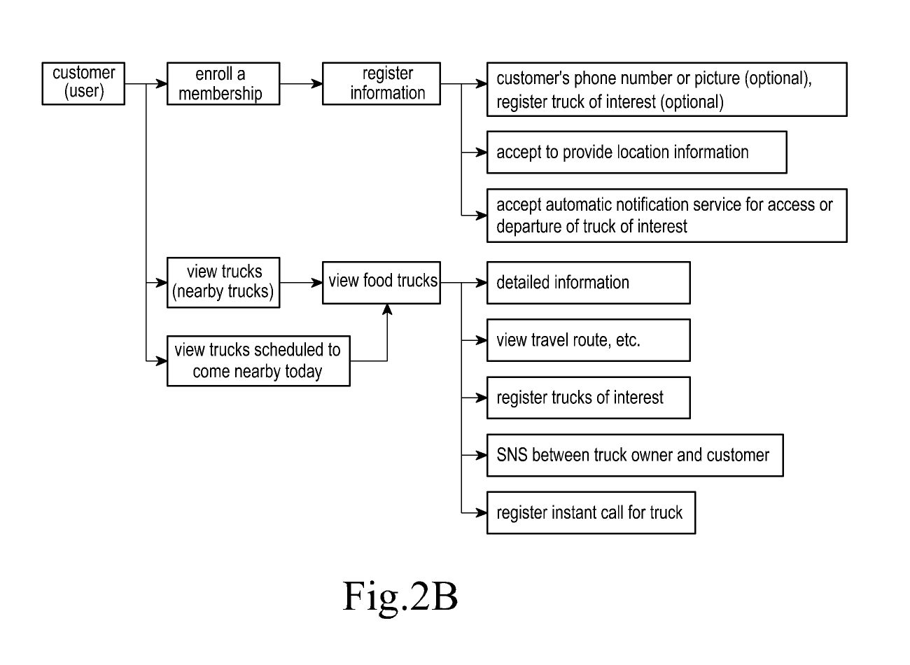

The information may be available to, e.g., the user or the owner, as the user or owner enrolls in membership and register information, and the information is recorded in the storage unit 500 through a process as illustrated in FIGS. 2A and 2B to be described below.

FIG. 2A is a view illustrating a process for enrolling in membership and registering information on a food truck owner.

Referring to FIG. 2A, the food truck owner may enroll in membership and register his/her various information (introduction/menu/business hour/today's travel schedule) and may disclose the information. According to an embodiment of the present disclosure, the food truck owner may issue coupons that may be used by the user.

FIG. 2B is a view illustrating a process for enrolling in membership and registering information on a user.

Referring to FIG. 2B, the user may enroll in membership and register his/her information (phone number/picture/schedule) and may disclose the information. The user may previously register a notification service for the food truck.

For example, the information searching system using location information may be a system connecting the food truck with the user. The user may search a food truck that fits his preference and location using the information (location information/pre-registered information), and the food truck owner may obtain a route along which the food truck is to travel using a locational distribution of users.

The messaging unit 400 may be configured to display the location of a food truck that is located within a distance preset by the user, based on the user's current location, and the messaging unit 400 may be configured to transmit a notification message.

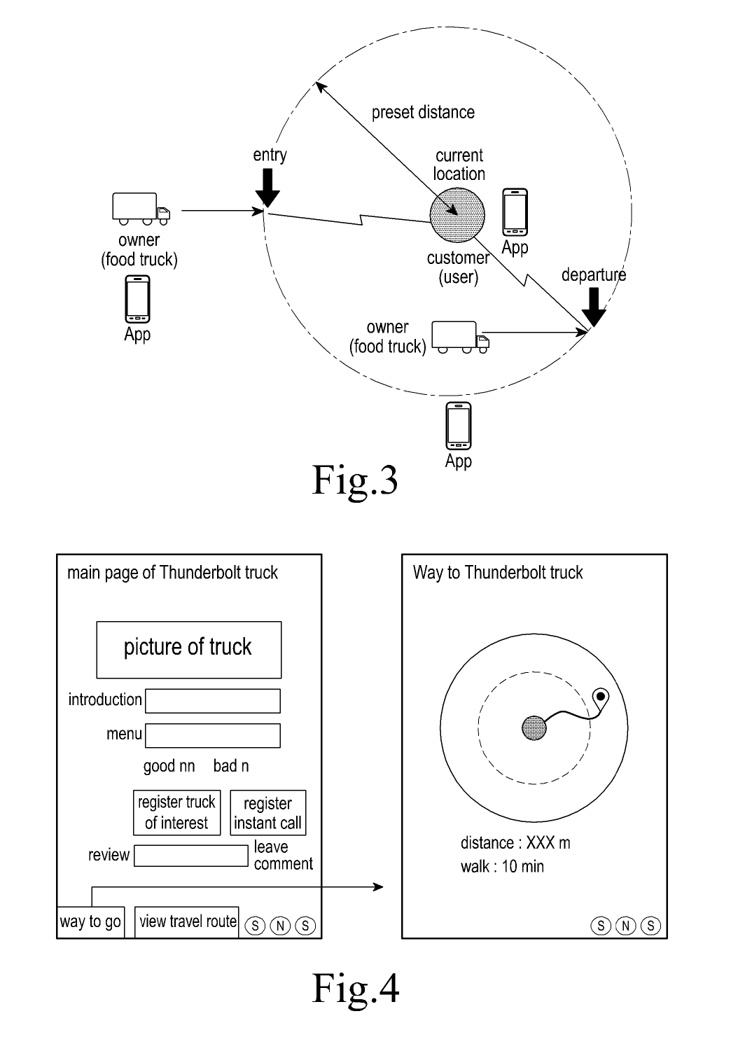

FIG. 3 is a view illustrating an example in which the location of a food truck located within a distance preset by a user is displayed and a notification message is transmitted, according to an embodiment of the present disclosure.

The user may directly set or modify a distance range (e.g., within a radius of 1 km of the user's current location) available to the user based on his/her location information. Based on the distance range, the location of a food truck located within the distance may in be displayed, and a notification message may be transmitted.

The notification message may include, but is not limited to, a sound or a pop-up message.

As shown in FIG. 3, when the food truck enters the distance range preset by the user, a notification message may be automatically transmitted, allowing the user to use the food truck. When the food truck departs from the distance range, a notification message may be transmitted, previously alerting the user of unavailability of the food truck. According to an embodiment of the present disclosure, notification messages for all of the trucks within the set distance may be sent to the user. Alternatively, when the user registers food trucks of interest, notification messages only for the registered food trucks of interest may be sent to the user.

For example, the user may search for a particular food truck and register the searched food truck as a food truck of interest. When the food truck of interest is located within a distance preset by the user, the location of the food truck may be displayed and a notification message may be sent to the user.

According to an embodiment of the present disclosure, the information searching system may further include a travel information providing unit 600 that may provide a travel route, a travel time, and a travel means based on location information between the user and the food truck.

The travel information providing unit 600 may provide the user with information related to travel, such as a way how to go to a particular truck and a time taken to go to the truck. An example is illustrated in FIG. 4, which is a view illustrating an example in which an information searching system provides travel information according to an embodiment of the present disclosure. The travel information may be automatically provided to the user when the user selects a particular truck or may be provided to the user when the user presses a “Way to go” button provided in a main page for the owner of the truck.

According to an embodiment of the present invention, the screen view as shown in FIG. 4 may be provided through a website available through a personal computer (PC) or a mobile website available through a mobile terminal.

According to an embodiment of the present disclosure, the information searching system may further include a food truck preference storage unit 520. The food truck preference storage unit 520 may store points evaluating the preference of food trucks.

According to an embodiment of the present disclosure, the food truck preference storage unit 520 may be included in the storage unit 500.

After using the food truck, the user ay evaluate the food truck to register a point for the evaluated food truck. The evaluation point may be stored in the food truck preference storage unit 520. When a plurality of food trucks are displayed to the user, the respective points of the food trucks may be displayed in order of preference. For example, the higher evaluation point a food truck has, the higher position the food truck may be located in the displayed list of food trucks. Accordingly, the user may be aware of which one of the plurality of food trucks provides more user satisfaction.

According to an embodiment of the present disclosure, when a plurality of food trucks enter an area that is within a distance preset by the user based on the user's current location as shown in FIG. 3, the location displaying unit 300 may list the food trucks in order of shortest travel route or travel time considering the user's travel route, travel time, and travel means. The list may be provided to the user using the information from the travel information providing unit 600.

The list may be provided in order of preference of the food trucks, e.g., based on the respective points of the food trucks evaluated by the user. The information may be provided through the e information stored in the food truck preference storage unit 520.

According to an embodiment of the present disclosure, the information searching system may allow the user to easily identify the information on the food truck while allowing the food truck owner to search for the user's location. Accordingly, the information searching system may contribute increased sales for the food truck owner.

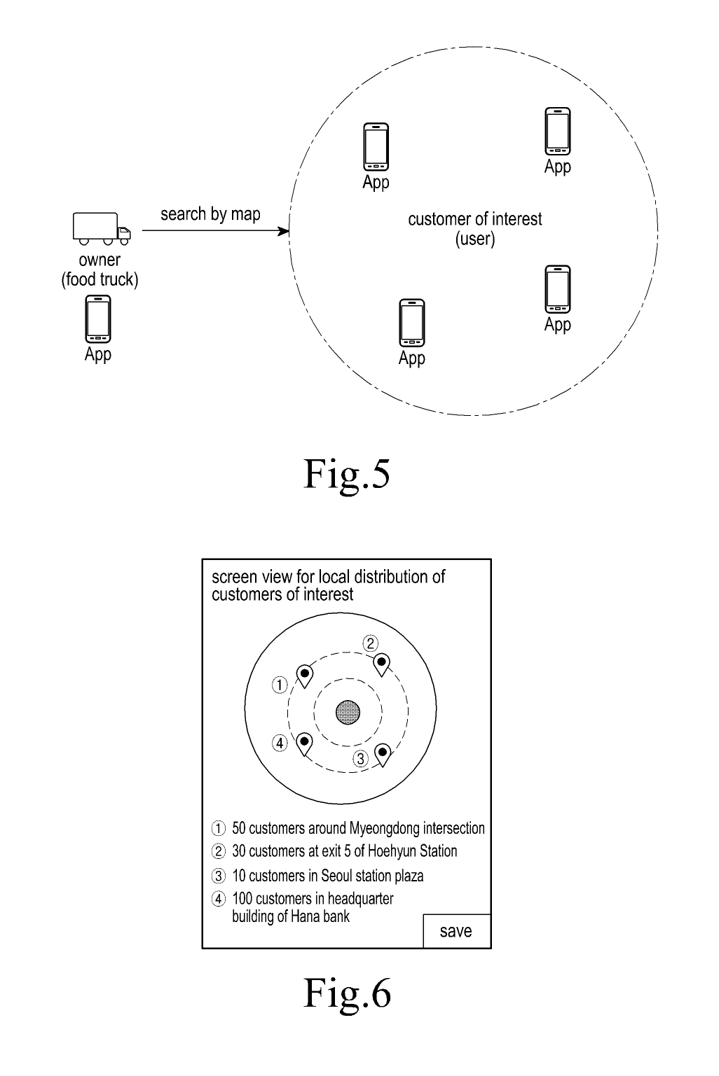

The location displaying unit 300 may search and display the current locations of users for the food truck owner as illustrated in FIG. 5 which is a view illustrating an example in which a food truck owner searches a user of interest for the user's location according to an embodiment of the present disclosure.

For example, the food truck owner may grasp a current location distribution of users using the information searching system and may determine a travel route of his food truck.

FIG. 6 is a view illustrating a screen displayed on a terminal of a food truck owner according to an embodiment of the present disclosure. The food truck owner may easily obtain a locational distribution of users.

According to an embodiment of the present invention, the screen view as shown in FIG. 6 may be provided through a website available through a personal computer (PC) or a mobile website available through a mobile terminal.

When users register calls for the food truck, the food truck owner may obtain a distribution of the users who have registered instant calls and information on the users, allowing the food truck owner to easily determine a travel route. Accordingly, the food truck owner may quickly access the users, thus increasing customer satisfaction while allowing the food truck owner to secure more regular customers.

According to an embodiment of the present disclosure, the food truck owner may register his/her schedule in advance, and the user may be previously aware of the travel route of the food truck. Accordingly, the user may predict his/her food consumption.

According to an embodiment of the present disclosure, the information searching system may further include a schedule storage unit 510 that stores a schedule of the food truck. The food truck owner may register and store his/her schedule in the schedule storage unit 510.

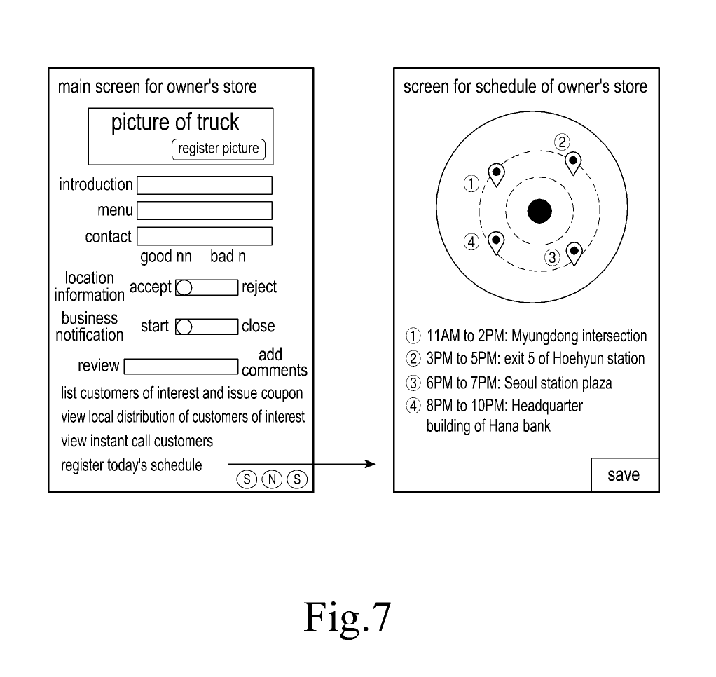

FIG. 7 is a view illustrating a screen on which a food truck owner registers a schedule according to an embodiment of the present disclosure.

Referring to FIG. 7, the food truck owner may register his/her schedule through his/her terminal. The registered schedule may be stored in the schedule storage unit 510. The user may identify the schedule of the food truck in real-time. When a schedule of a food truck that is registered by the user as a food truck of interest is registered, the schedule may be automatically sent to the user through a notification message.

According to an embodiment of the present invention, the screen view as shown in FIG. 7 may be provided through a website available through a personal computer (PC) era or a mobile website available through a mobile terminal.

As a schedule of the food truck is previously registered and sent to the user, the user may predict his/her food consumption.

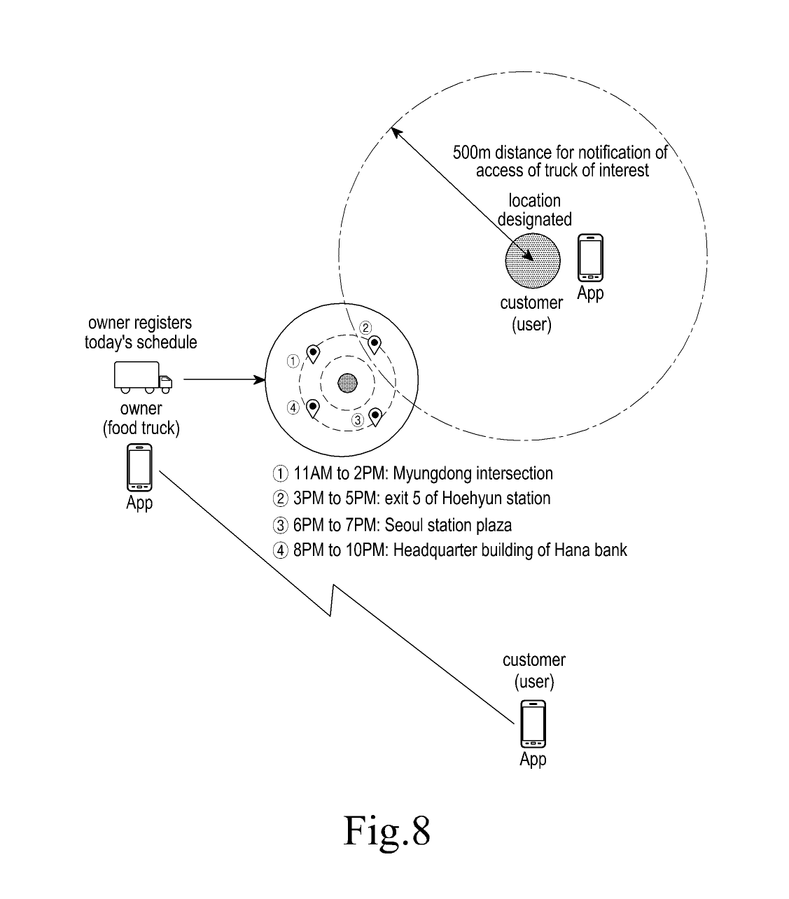

FIG. 8 is a view illustrating an example in which a notification message is sent to a user so that the user may predict his/her consumption of food from a food truck whose schedule has been previously registered, according to an embodiment of the present disclosure.

Referring to FIG. 8, when the food truck owner registers his/her schedule, the user may identify the schedule. When there is a food truck predicted to come within a distance preset by the user based on the schedule stored in the schedule storage unit 510 with respect to the user's current location, the information searching system may send a notification message to the user. Accordingly, the user may predict his/her food consumption.

According to an embodiment of the present disclosure, the food truck owner may register a discount coupon. A history of the issue of discount coupons may be stored in the storage unit 500. When a discount coupon is issued, the user may search for the discount coupon in real-time. When the user sets the food truck to a food truck of interest, a history of the issue of discount coupons may be sent to the user in a notification message.

According to an embodiment of the present disclosure, a testimonial or use history for the food truck may be registered through a Social Network Service (SNS).

As will be appreciated by one skilled in the art, aspects of the present disclosure may be embodied as a system method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or y suitable combination of the foregoing. More specific examples (a non-exhaustive Hat) of the computer readable storage medium would include the following: an electrical connection having one or more wires, a portable computer diskette, a hard disk, a RAM, a ROM, an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server, In the latter scenario, the remote computer may be connected to the user's computer through any type of network, including a local area network (LAN) or a wide area network (WAN), or the connection may be made to an external computer for example, through the Internet using an Internet Service Provider).

Aspects of the present disclosure are described with reference to flowchart illustrations and/or block diagrams of methods, apparatus (systems) and computer program products according to embodiments of the present disclosure. It will be understood that each block of the flowchart illustrations and/or block diagrams, and combinations f blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article or manufacture including instructions which implement the function act specified in the flowchart and/or block diagram block or blocks.

The computer program instructions may also be loaded onto a computer, other programmable data processing apparatus, other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical functions(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present disclosure has been shown and described with reference to exemplary embodiments thereof, it will be apparent to those of ordinary skill in the art that various changes in form and detail may be made thereto without departing from the spirit and scope of the present disclosure as defined by the following claims.

What is claimed is:

1. A food truck and user searching system using location information, comprising:
a location tracking unit tracking a current location of a user and a current location of a food truck using a communication terminal;
a location displaying unit displaying the current location of the user and the current location of the food truck based on location information obtained through the location tracking unit;
a messaging unit computing a distance between the user and the food truck, and when the distance is within a predetermined distance, sending a notification message;
a travel route and travel means providing unit providing a travel route and a travel means based on the location information between the user and the food truck; and
a schedule storage unit storing a schedule of the food truck, wherein a location of a food truck located within a distance preset by the user based on the current location of the user is displayed, and a notification message is sent, and wherein when there is a food truck predicted to come within the distance preset by the user based on the current location of the user based on the schedule stored in the schedule storage unit, a notification message is sent.

2. The food truck and user searching system of claim 1, wherein the location displaying unit searches and displays the current location of the user to an owner of the food truck based on the current location of the food truck.

3. The food truck and user searching system of claim 1, further comprising a food truck preference storage unit storing an evaluation point of the food truck, wherein information on an evaluation point of the food truck evaluated by the user is stored in the food truck preference storage unit.

4. The food truck and user searching system of claim 3, wherein when the food truck comes within the distance preset by the user based on the current location of the user, the location displaying unit lists food trucks in order of a shortest travel route or travel time considering a travel route, travel time and travel means of the user or lists the food trucks in order of preference of the food trucks.

5. The food truck and user searching system of claim 1, wherein the user may search a food truck and register a particular food truck as a food truck of interest, and wherein when the food truck of interest is located within the distance preset by the user, a location of the food truck of interest is displayed, and a notification message is sent.
